(19) United States
(12) Patent Application Publication
(10) Pub. No.: US 2007/0018615 A1
(43) Pub. Date: Jan. 25, 2007

(54) Device and method for determining operating parameters of a battery

(75) Inventors: Hans-Michael Graf, Bad Abbach (DE); Maximilian Lang, Regensburg (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/180,828

(22) Filed: Jul. 13, 2005

(30) Foreign Application Priority Data
Jul. 13, 2004 (DE) 10 2004 033 836.1

(51) Int. Cl. H02J 7/00

(52) U.S. Cl. 320/160

(57) ABSTRACT

A device monitors the operating parameters of a battery, in particular a starter battery for an automobile. The operating parameters include at least the battery voltage and the device is supplied from the battery voltage. For power-saving and yet precise determination of operating parameters for the period of time which is particularly significant in practice after a drop in the battery voltage, the device comprises a battery parameter detection device which determines the operating parameters of the battery in an awake state, stores these in digital form and/or supplies them to a digital interface output. The detection device is inactive in a sleep state and has a reduced consumption of electricity. A cut-off detection device compares the battery voltage with the predetermined cut-off voltage during the sleep state and awakens the detection device from the sleep state if the battery voltage falls below the predetermined cut-off voltage.

### BACKGROUND OF THE INVENTION

### Field of the Invention

The present invention relates to a device and also a method for determining operating parameters of a battery, in particular a starter battery in a motor vehicle.

The starter battery in a motor vehicle supplies the energy for the start-up of the motor. The loss of stored energy associated with the starting process is compensated for while the motor is in operation by the supply of energy from an electrical generator driven by the motor. The battery is nevertheless subjected to numerous influences and ageing processes so that a series of operating parameters in the starter battery are determined and evaluated in motor vehicles with modern vehicle electronics. This produces two considerable advantages. Firstly, the determination of the operating parameters provides the basis for a notification to the driver of certain irregularities in the vehicle electrics (e.g. excessively increased consumption of electricity) or for a warning of an imminent battery failure. Secondly, operating parameters determined in this way can be stored in digital form and can be read-out as fault diagnosis parameters during a repair or maintenance of the vehicle by service personal in order to acquire information about irregularities having occurred in the past.

A device of the foregoing type is described, for example, in German published patent application DE 199 52 693 A1. The prior art device serves to determine the status of a starter battery for a motor vehicle and thereby detects the battery voltage, the battery temperature, the charging current, the discharge current and/or the no-load current. These operating parameters are measured in this case at constant or dynamically selected intervals and are evaluated by means of a microprocessor. The characteristics of the battery to be monitored and the detected operating parameters of the battery are stored in a data memory in the microprocessor system. A service interface allows the data to be read out, e.g. for the service station and a reinitialization in the event of the battery exchange in the vehicle.

Advantageously the measurement of the operating parameters at constant or dynamically selected intervals saves energy, which must be supplied by the battery and thus allows the collection of time-resolved operating parameter data. This is particularly significant if the detection takes place in a vehicle which has been parked for a long time, since in this case the energy consumed by the operating parameter measurement can not be replenished by the electrical generator.

One disadvantage with the prior art device is that a detection of operating parameters is not reliably ensured in the event of a massive drop in the battery voltage, in particular in the timeframe immediately prior to the device failing as a result of undervoltage. Even if a detection takes place in a timeframe of this type, it is disadvantageous with the known device that the operating parameter data collected immediately prior to a device failure resulting from undervoltage often does not allow particularly precise conclusions to be drawn on the cause of the undervoltage. The most precise detection of the operating parameters possible is however desirable in this very timeframe immediately prior to the failure of the battery, because this would make it possible to identify different causes of the fault more precisely.

### SUMMARY OF THE INVENTION

It is accordingly an object of the invention to provide a method and a device for determining the operating parameters of a battery which overcomes the above-mentioned disadvantages of the heretofore-known devices and methods of this general type and which improves the detection of operating parameters in a battery to that effect that battery interferences or the electrical consumer system operated therewith can be diagnosed in as detailed a manner as possible.

With the foregoing and other objects in view there is provided, in accordance with the invention, a device for determining operating parameters of a battery, in particular a starter battery of a motor vehicle. The device comprises:
an operating parameter detection device configured to operate in an awake state and in a sleep state, said operating parameter detection device determining operating parameters in the battery in the awake state, and storing the operating parameters in digital form and/or providing the operating parameters at a digital interface output, and said operating parameter detection device being inactive in the sleep state and having reduced consumption of electricity relative to the awake state; and
a cut-off voltage detection device connected to said operating parameter detection device, said cut-off voltage detection device, at least in the sleep state of said operating parameter detection device, permanently comparing the battery voltage with a predetermined cut-off voltage and, when the battery voltage falls below the predetermined cut-off voltage, bringing about a transition of said operating parameter detection device from the sleep state into the awake state.

With the above and other objects in view there is also provided, in accordance with the invention, a method for determining operating parameters of a battery, the operating parameters including a battery voltage and the device being supplied from the battery voltage, the method which comprises:
switching an operating parameter detection device between an awake state and a sleep state;
   in the awake state, operating the operating parameter detection device to determine the operating parameters of the battery and to store the operating parameters in digital form and/or to output at a digital interface output; and
   in the sleep state, inactivating the operating parameter detection device and causing the operating parameter detection device to have reduced current consumption in comparison with the awake state; and
at least in the sleep state of the operating parameter detection device, continuously comparing the battery voltage with a predetermined cut-off voltage and, if the operating voltage falls below the predetermined cut-off voltage, bringing about a transition of the operating parameter detection device from the sleep state into the awake state.

In other words, there is provided an operating parameter detection device which can be operated in two different states. A number of operating parameters of the battery are determined in a first state known as an ‘awake state’. By contrast, this device is inactive in a state termed as ‘sleep state’, during which considerably less electricity is consumed in comparison with the awake state. The change-over between the awake state and the sleep state can be initiated in numerous ways. In particular an awake state continuing over a predetermined period of time can be provided at constant or dynamically selected intervals, whether it be controlled by means of an internal time emitter device or by an external control device (e.g. electronic control unit). It is nevertheless also essential for the invention to provide for a cut-out detection device which permanently compares the battery voltage with a predetermined cut-off voltage at least in the sleep state of the operating parameter detection device, and which brings about the transition from the sleep state to the awake state if this cut-off voltage is undershot.

The combination of these measures enables a particularly power-saving and yet precise determination of operating parameters for the time frame which is particularly significant in practice, said determination occurring immediately after the battery voltage has dropped, and thus an improved diagnosis of the cause for the reduction in the battery voltage.

The term ‘operating parameter’ includes variables to be measured immediately at the battery (e.g. battery voltage, battery current, charging current and discharge current, temperature etc.) as well as deducible variables e.g. calculable variables from measurement variables of this type, which are characteristic for the state of the battery (e.g. internal resistance, voltage ripple, current ripple etc.) The operating parameters are thus determined by measurement and/or deduction from the measured variables.

In a preferred embodiment the measured operating parameters comprise at least the battery voltage, the battery current and the temperature measured in or immediately on the battery.

The internal resistance, a state of charge (SOC) and/or a state of health (SOH) are of particular interest as deduced operating parameters. The manner of determining and or the possibility of defining these operating parameters are well-known to the person skilled in the art (see e.g. DE 199 52 693 A1 mentioned at the start) and therefore do not require a more detailed explanation.

Provided the device has a data link with an external control device such as an electronic control unit and/or an on-board vehicle computer, the functions required to deviate from the operating parameters can also be relocated partly or wholly onto external devices of this type, above all the latter devices are often available with comparatively large computing capacity. If a data link of this type does not only comprise an interface output on the device but also an interface input, the possibility advantageously exists of also initiating the transition between the awake state and the sleep state of the device mentioned by means of an external device of this type, and/or of transferring the default data relating to this state to the device. This type of default data can for example command the temporal sequence of awake and sleep states during normal operation (battery voltage lying above the cut-off voltage). Alternatively or in addition an external-device can also transmit criteria to the device, by means of which the device is then able to trigger the transition between the awake state and the sleep state.

In a preferred embodiment, the device is configured as a compact unit with the dimensions of a few centimeters, comprising a housing to enclose and isolate the electronic components as well as a battery terminal to be connected directly to one connection of the battery. In one embodiment for the starter battery of a motor vehicle, this unit can be designed in particular to be accommodated in the so-called battery pole niche, with the battery terminal preferably also being provided for connection to the negative battery pole and the unit further being provided with a low-resistance earth cable which is connected to a battery terminal (for connection to a part of the car body) as well as at least one supply cable for connection to a positive supply potential. Two supply cables of this type can also be provided to connect the device to the positive battery potential (terminal 30) on the one hand and to a positive potential (e.g. terminal 15) when electrical loads are switched on on the other hand.

If the operating parameters of the battery determined in the awake state are stored in digital form, as is preferable, a non-volatile memory (e.g. EEPROM, Flash) is preferably used here, in which case, for reasons of speed for example, temporary storage in a volatile memory (e.g. RAM) can be provided, which can also be used for example as a program memory for a microprocessor device,. The non-volatile storage of digital operating parameter data (measurement data and derived battery state data) is advantageous in that, after a device failure as a result of undervoltage, after operation has been resumed (e.g. microprocessor reset after the voltage increases again), the stored data can be transmitted to an external device (e.g. superior control device) for evaluation purposes. Alternatively or in addition, the operating parameters determined in the awake state can be supplied to a digital interface output, so that default data relating to future operating parameter determinations to be carried out can be transmitted back to the device on the basis of an evaluation of this data through an external device via an interface input for instance.

To enable a continuous comparison of the battery voltage with the predetermined cut-off voltage in the sleep state, the device comprises in a preferred embodiment an analog comparator circuit which is supplied with both the battery voltage or a voltage derived therefrom, in particular a separated battery voltage), as well as the cut-off voltage, and at whose output the signal for ‘waking up’ the device is provided. The cut-off voltage is preferably generated from the battery voltage, e.g. by a regulated step-down transformer which can be integrated into the device. In order to obtain the lowest possible consumption of electricity in the sleep state, the comparator circuit should be designed as simply as possible and in particular work completely independently of device parts which are provided in the awake state in order to ensure the most precise operating parameter measurement possible. The latter circuit parts for measured value recording are embodied in a preferred form as sensors with a downstream A/D converter device, in order to provide digital measurement data suitable for direct storage or interface output. These latter sensor elements which have comparatively high power consumption, including a microprocessor device to control them if necessary, should be switched off during sleep state. Apart from comparing the battery voltage with the cut-off voltage, the device does not carry out any further determination activities in the sleep state.

The transition from the sleep state into the awake state if the cut-off voltage is undershot is preferably provided such that the awake state is maintained at least for a predetermined period so as to determine a prespecified series of operating parameters and to save these immediately as non-volatile data. By way of example, a number of pairs of values can be measured for battery voltage and battery current and stored in the memory.

The cut-off voltage is preferably predetermined within a range of 10% to 80% of the battery voltage which is produced with the fully charged and healthy battery without electrical load (idling). In a device provided for the 12 V starter battery in a motor vehicle, the cut-off voltage preferably lies within a region of 3V to 9V.

The device preferably comprises an energy store for temporary maintenance of the operation of the device in the event of a battery voltage failure. In this context, the term ‘Battery voltage failure’ refers to the voltage down to which the device can still be operated properly. This failure voltage lies in the region between 0V and the cut-off voltage, as a function of on the actual implementation of the device. The energy store can be a capacitor for example which is charged at intervals with an sufficiently high voltage of the battery to be monitored and thus makes it possible to continue to operate the device after a battery voltage failure for a period sufficient for the non-volatile storage of a few operating parameters.

After a transition from the sleep state to the awake state brought about by the cut-off detection device, the operating parameter detection device is preferably configured to determine a predetermined series of operating parameters and to save these in digital form as non-volatile data.

Furthermore it is preferable for the device to feature a digital interface output for outputting the operating parameters determined and/or stored in digital form, and/or a digital interface input for inputting control signals. The interface can for example be provided for a standardized bus system such as a CAN bus or a LIN bus. In a preferred embodiment, the device is provided as a LIN slave and is in a data link with an external control device (LIN master).

Since according to the invention a sleep state of the operating parameter detection device is provided, in which no permanent and comparatively costly measurement (and evaluation) of operating parameters takes place, a large number of electronic components of the device can thus be operated in idle mode with reduced power consumption. An awakening of the operating parameter detection device and its transition back into the sleep state can be triggered using different events. By way of example, an awakening can be provided in intervals, in particular in periodic intervals, with the period between these awake times able to be adjusted. Furthermore, a development of the invention provides for the device to be woken up when a selectable battery idle current is undershot. Finally the device can be woken up when the predetermined cut-off voltage is undershot. This latter case is particularly relevant in practice, since important information relating to the causes of faults can be obtained by determining operating parameters after a drop in the battery voltage. A distinction of the following fault cases can be provided for example:
Deep discharge (Voltage relatively constant over 0V)
Polarity reversal as a result of an external start up (voltage dropping quickly to below 0V)
Disconnection of the battery (Voltage quickly dropping to 0V)
Short circuit of the vehicle electrical system (voltage exceeds 0V, high current)
External start with an excessively high voltage (voltage increasing far too rapidly)
etc.

The information important for this type of distinction can usefully be read out during the workshop service.

Other features which are considered as characteristic for the invention are set forth in the appended claims.

Although the invention is illustrated and described herein as embodied in a device and method for determining operating parameters of a battery, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows a block diagram of the installation environment of a battery sensor module; and

FIG. 2 shows a schematic block diagram of the battery sensor module from FIG. 1.

### DESCRIPTION OF THE PREFERRED EMBODIMENTS

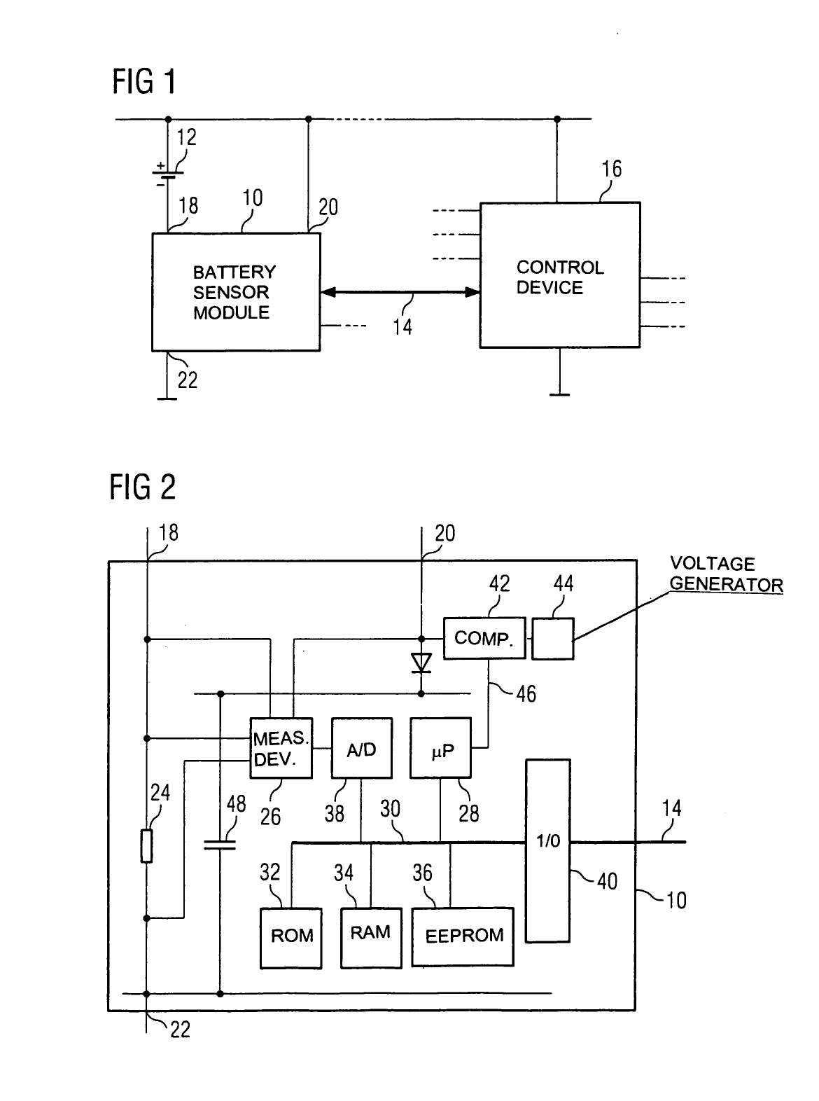

Referring now to the figures of the drawing in detail and first, particularly, to FIG. 1 thereof, there is shown a battery sensor module 10 for determining operating parameters in a starter battery 12 in a motor vehicle. The module 10 is installed as a compact unit in the negative pole niche of the battery 12 in order to measure the battery voltage, the battery current and the battery temperature.

Furthermore, the module 10 determines a series of deduced operating parameters in the battery from the directly measured parameters, in order to store these temporarily together with the measurement variables and from time to time to transmit these to a superior control device 16 via a LIN bus 14. The control device 16 is configured as a LIN master and handles the central monitoring and control functions of the vehicle electronics, in particular engine management.

The module 10 has a negative supply connection 18 configured as a battery post terminal, a positive supply connection 20 to be connected to the positive battery potential and a ground connection 22 to be connected to a vehicle ground. The module 10 configured as a LIN slave can be operated in an awake state, in which operating parameters of the battery are determined, and in which in the sleep state only the current battery voltage is compared to a predetermined cut-off voltage. A temporary transition from the sleep state to the awake state can be triggered by a corresponding control command and/or control input from the control device 16, by a period set in advance by the control device 16 elapsing and in the case in which the current battery voltage drops below the cut-off voltage.

FIG. 2 shows a schematic representation of the design of the battery sensor module 10. The negative supply connection 18 is directly connected to the ground connection 22 by way of a shunt resistor 24 (resistance less than 100 μΩ), to guarantee on the one side a reliable current conveyance from the vehicle ground to the negative battery pole and on the other side to measure the battery current flowing through the shunt 24. For this measurement, the voltage dropping at the shunt 24 is fed to a measurement device 26. In a variation on the exemplary embodiment shown, the battery current measurement could also be effected by means of a magnetic field sensor (e.g., Hall probe).

To measure the battery voltage, the voltage between the connections 18 and 20 is also fed to the measurement device 26.

The temperature measurement (not shown in the figure), is similarly undertaken using the temperature sensor connected to the measurement device 26 arranged in the region of the negative supply connection 18.

Furthermore, the module 10 comprises a microprocessor device designed as a microcontroller (μP) 28, which is connected to a ROM memory 32, a RAM memory 34, an EEPROM memory 36, an A/D converter 38 and an input/output interface 40 by way of a bus 30.

The circuit components 26 to 40 form a part of an operating parameter detection device which is important for the awake state. The operating parameter detection device determines a plurality of operating parameters in the battery 12 in the awake state and stores these as non-volatile data in the EEPROM memory 36 in digital form, and/or provides these to the control device 16 by means of the interface 40. The ROM memory 32 stores an operating system for the microcontroller 28, which is supplemented by changeable software components which are stored in the RAM memory 34. The variables measured in analog form by the measurement device 26‘are converted into digital measurement data by means of the A/D converter 38 and are stored in the EEPROM memory 36 together with the data deriving therefrom and relating to the battery (e.g. internal resistance, SOC, SOH etc.). The data stored in the EEPROM memory 36 is transmitted from time to time (e.g. after the ‘wake up’ of the module resulting from the timeout) or on demand from the control device 16 via the interface 40 to the control device 16 where it is to be evaluated, reused if necessary and stored in a non-volatile manner. Data successfully transmitted to the control device 16 is thereafter deleted in the EEPROM memory 36.

In the awake state of the operating parameter detection device, a comparatively large amount of current (here approx. 20 mA) is consumed which causes particular problems with a vehicle which has been parked up for a long time. To lower the current consumption in these phases in particular, the sleep state of the operating parameter detection device is provided, which alternates over the life cycle of the module 10 with the awake states and in which the current consumption is drastically reduced (here to less than 100 μA). This is preferably made possible by an operating current consumption reduced by at least a factor of 1000 by turning off a large number of components in the microcontroller system. Accordingly in the sleep state, no A/D conversion nor storage of any type of operating parameters of the battery 12 can take place. Instead, in the sleep state, the battery voltage is merely permanently compared to a 5V predetermined cut-off voltage, in order to re-awaken the operating parameter detection device in the event of the current battery voltage dropping below this cut-off voltage. For this purpose, the battery sensor module 10 comprises a comparator 42 which is fed both the positive battery potential via connection 20 and also the cut-off voltage potential supplied by a cut-off voltage generator 44, so that the microcontroller 28 can be reactivated via a signal line 46 in a corresponding comparison result, so as to trigger a temporary transition from the sleep state to the awake state.

The cut-off voltage generator 44 is supplied with power in this case from the battery voltage itself which is buffered within the module 10 by means of a capacitor 48. This enables module 10 to also be fully functional for a short time (here approx 15 ms) even with a battery voltage which has fallen well below the cut-off voltage.

In this, under some circumstances, very short awake phase, a series of predetermined operating parameter determinations are then carried out, the results of which are stored in the EEPROM memory 36. This data which is important for a fault diagnosis is transmitted immediately or subsequently to the control device 16, by means of the interface 40.

If data not yet transmitted to the control device 16 is still contained in the EEPROM memory 36 after a total failure of the monitored battery, e.g. after its disconnection, this data is transmitted to the control device 16 directly after operation has been resumed, e.g. by connecting a new battery.

The operating parameter data collected over a long period of time is stored in the control device 16 as non-volatile data and can thus be read out during a vehicle service.

This application claims the priority, under 35 U.S.C. § 119, of German patent application No. 10 2004 033 836.1, filed Jul. 13, 2004; the entire disclosure of the prior application is herewith incorporated by reference.

We claim:

1. A device for determining operating parameters of a battery, comprising:
an operating parameter detection device configured to operate in an awake state and in a sleep state, said operating parameter detection device determining operating parameters in the battery in the awake state, and storing the operating parameters in digital form and/or providing the operating parameters at a digital interface output, and said operating parameter detection device being inactive in the sleep state and having reduced consumption of electricity relative to the awake state; and
a cut-off voltage detection device connected to said operating parameter detection device, said cut-off voltage detection device, at least in the sleep state of said operating parameter detection device, permanently comparing the battery voltage with a predetermined cut-off voltage and, when the battery voltage falls below the predetermined cut-off voltage, bringing about a transition of said operating parameter detection device from the sleep state into the awake state.

2. The device according to claim 1, configured for determining the operating parameters of a starter battery of a motor vehicle, the operating parameters including at least an operating voltage, and the device being supplied from the battery voltage.

3. The device according to claim 1, which further comprises an energy storage device for temporarily maintaining an operation of the device during failure of the battery voltage.

4. The device according to claim 1, wherein said operating parameter detection device, after a transition from the sleep state into the awake state has been brought about by said cut-off voltage detection device, determining a predetermined sequence of operating parameters and storing the operating parameters in digital form as non-volatile data.

5. The device according to claim 1, which comprises a digital interface output for outputting the operating parameters.

6. The device according to claim 1, wherein said digital interface output is configured to output the operating parameters upon being determined and/or saved operating parameters in digital form.

7. The device according to claim 1, further comprising a digital interface input for inputting control signals.

8. The device according to claim 1, wherein said operating parameter detection device comprises:
a measurement device for measuring analog operating variables of the battery;
an A/D converter device for converting the measured operating variables into digital measurement data;
a storage device for storing the digital measurement data and/or status data derived therefrom; and
a microprocessor device for controlling an operation of at least one of said measurement device, said A/D converter device, said storage device, and/or for calculating status data from the digital measurement data.

9. A method for determining operating parameters of a battery, the operating parameters including a battery voltage and the device being supplied from the battery voltage, the method which comprises:
switching an operating parameter detection device between an awake state and a sleep state;
in the awake state, operating the operating parameter detection device to determine the operating parameters of the battery and to store the operating parameters in digital form and/or to output at a digital interface output; and
in the sleep state, inactivating the operating parameter detection device and causing the operating parameter detection device to have reduced current consumption in comparison with the awake state; and
at least in the sleep state of the operating parameter detection device, continuously comparing the battery voltage with a predetermined cut-off voltage and, if the operating voltage falls below the predetermined cut-off voltage, bringing about a transition of the operating parameter detection device from the sleep state into the awake state.

10. The method according to claim 9, which comprises monitoring a starter battery of a motor vehicle.
